(19) United States
(12) Patent Application Publication
(10) Pub. No.: US 2024/0044163 A1
(43) Pub. Date: Feb. 8, 2024

(54) POOL COVERS FOR SWIMMING POOLS AND SPAS

(71) Applicant: ZODIAC POOL SYSTEMS LLC, Carlsbad, CA (US)

(72) Inventors: Darin Eames, Carlsbad, CA (US); Dindo Uy, North Hollywood, CA (US); Mark J. Bauckman, San Marcos, CA (US); Robert Warren Stiles, JR., San Marcos, CA (US)

(73) Assignee: ZODIAC POOL SYSTEMS LLC, Carlsbad, CA (US)

(21) Appl. No.: 18/231,590

(22) Filed: Aug. 8, 2023

Related U.S. Application Data
(60) Provisional application No. 63/396,045, filed on Aug. 8, 2022.

(51) Int. Cl. E04H 4/14; E04H 4/08

(52) U.S. Cl. CPC E04H 4/148; E04H 4/082

(57) ABSTRACT

A pool cover for a swimming pool or spa may provide a changeable or adjustable visual indication. A method of controlling the pool cover may include controlling a visual indicator on the pool cover. A pool cover for a swimming pool or spa may include a surface water sensor for detecting at least one characteristic of water accumulated on the pool cover.

### REFERENCE TO RELATED APPLICATION

The application claims the benefit of U.S. Provisional Application No. 63/396,045, filed on Aug. 8, 2022, and entitled POOL COVERS FOR SWIMMING POOLS AND SPAS, the content of which is hereby incorporated by reference in its entirety.

### FIELD OF THE INVENTION

The invention relates to water-containing vessels such as swimming pools and spas and more particularly to covers for swimming pools and spas.

### BACKGROUND OF THE INVENTION

Pools, spas, and other water containing vessels are often covered when not in use for a number of reasons including, but not limited to, limiting evaporation of water and chemicals, retaining heat, and acting as a barrier to materials that may fall into the pool. In addition to pools and spas, other spaces such as ponds or water features may also be selectively covered. Pool covers for swimming pools or spas traditionally have served a sole function of acting as a barrier, and such pool covers may be manually or automatically positioned between a covering position (i.e., covering the pool or spa) and an open position (i.e., allowing access to the pool or spa). In the covering position, the pool covers are exposed to environmental conditions, and after extended use, pool covers may be unsightly in the covering position due to wear, sagging, and/or other damage due to such use.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool cover for a swimming pool or spa includes integrated lighting.

According to various embodiments, a pool cover for a swimming pool or spa includes a photosensitive material.

According to certain embodiments, a pool cover for a swimming pool or spa includes a media reflective surface.

According to various embodiments, a pool cover for a swimming pool or spa includes a controllable visual indicator.

According to some embodiments, a pool cover for a swimming pool or spa may provide a pool system status.

According to certain embodiments, a pool cover for a swimming pool or spa includes a solar panel.

According to various embodiments, a method of providing a pool system status includes controlling a visual indicator on a pool cover based on the pool system status.

According to some embodiments, a pool cover includes a surface water sensor for detecting at least one characteristic of water accumulated on the pool cover.

According to certain embodiments, a drainage system for a pool cover includes a surface water sensor for detecting at least one characteristic of water accumulated on the pool cover and drainage means controllable based on information from the surface water sensor.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool cover system according to embodiments.

FIG. 2 illustrates a pool cover system according to embodiments.

FIG. 3 illustrates a pool cover system according to embodiments.

FIG. 4 illustrates a pool cover system according to embodiments.

### DESCRIPTION OF THE INVENTION

Described herein are improved pool covers for swimming pools and spas.

According to certain embodiments, pool covers described herein provide changeable and/or adjustable visual indications for entertainment, providing information to a user (e.g., pool system status), and/or as otherwise desired. In some embodiments, the pool covers described herein may provide digital images as visual indications, although they need not be in other embodiments. In various embodiments, the visual indicator may be the pool cover itself, and the pool cover includes materials suitable for providing adjustable visual indications such as photo-sensitive materials, media reflective materials, and/or other materials or combinations as desired. In some embodiments, a visual source, such as but not limited to, a light source (e.g., a light emitting diode (LED)) may be provided adjacent to an edge of the pool cover such that light from the light source is directed into or onto the pool cover for providing the visual indication. Additionally, or alternatively, a visual indicator such as but not limited to an LED may be provided at various locations on the pool cover.

According to various embodiments, improved pool covers described herein may include an on-board power source, such as but not limited to one or more batteries and/or one or more solar panels for generating electricity from sunlight. In some embodiments, the pool covers described herein may include one or more solar panels that may store and/or generate energy that may be utilized for other components of the pool cover such as but not limiting to the light source(s). In other embodiments, the energy generated by the solar panels may be utilized for other components on the pool cover and/or within a pool system as desired. In various embodiments, the one or more solar panels may be flexible, and in some embodiments, the solar panels may be integrated with the pool covers such that the solar panels are rolled up and/or otherwise stowed with the pool cover.

According to some embodiments, improved pool covers described herein include improved drainage systems. Such drainage systems may be provided with pool covers having the aforementioned visual indications, although in other embodiments the drainage systems need not be provided with pool covers having visual indications. In certain embodiments, the drainage systems described herein include sensing means for sensing one or more characteristics of water accumulated on the pool cover. The sensing means may be communicatively coupled with various components or features for controlling drainage of the water from the pool cover based on the sensed information, thereby providing improved drainage control.

Various other benefits and advantages may be realized with the devices and methods provided herein, and the aforementioned advantages should not be considered limiting.

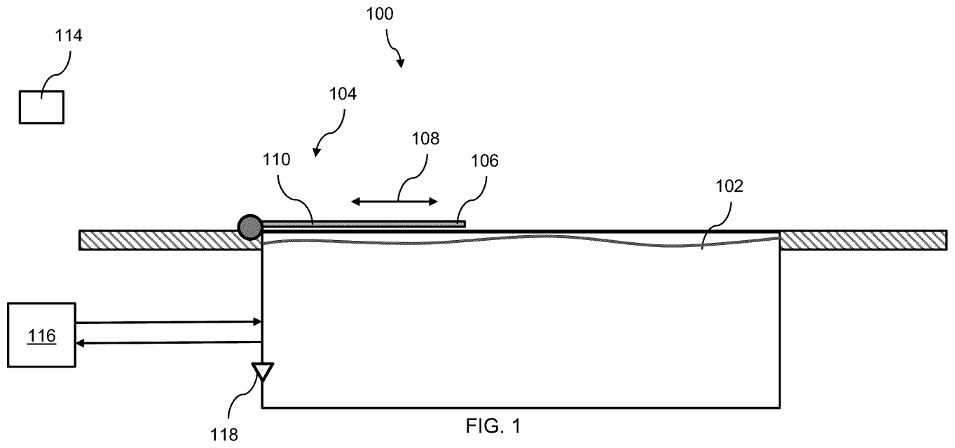

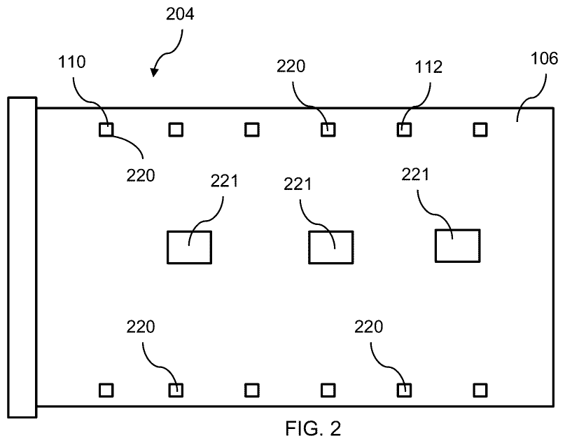

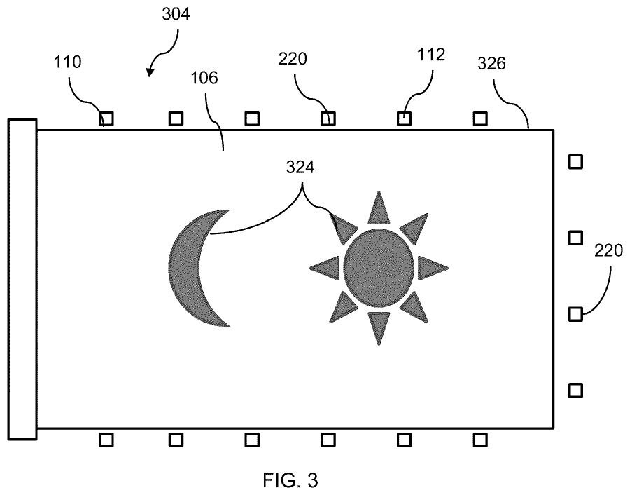

FIG. 1 illustrates a pool system 100 with a pool 102 having a pool cover system 104 according to embodiments. The pool cover system 104 includes a pool cover 106 that may be adjustable (represented by arrow 108) between a covering position and an open position. The pool cover system 104 includes visual indication means 110 for providing visual indications or information on the pool cover 106. The visual indication means 110 may be the material of the pool cover 106 itself and/or visual indication devices 112 (see FIGS. 2 and 3) on and/or adjacent to the pool cover 106. In the embodiment illustrated in FIG. 1, the visual indication means 110 include the pool cover 106 itself, and the pool cover 106 includes materials suitable for providing adjustable visual indications such as photo-sensitive materials, media reflective materials, and/or other materials or combinations as desired. In some cases, the visual indication devices include integrated lighting.

Optionally, the pool cover system 104 may include a controller 114. The controller 114 may include a computer system and/or one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. The memory device may be local to the controller, portable, on a server, or in the cloud, among other locations.

The controller 114 may be provided at various locations relative to the pool cover system 104, including local to the pool cover system 104 and/or at a location remote from the pool cover system 104. In certain embodiments, the controller 114 optionally includes an associated user interface, including but not limited to a graphical user interface or a human machine interface, such that the controller 114 may obtain information from a user and/or provide information to the user. Optionally, the interface may include features such as but not limited to a speaker, screen, touchpad, lights, switches, combinations thereof, and/or other human machine interfaces as desired for receiving information from and/or providing information to a user. The user interface and/or human machine interface may be on the controller 114 itself or may be at a location remote from the controller 114, such as on a user device, a dedicated user interface device, an operations control center remote from the pool cover system 104, combinations thereof, and/or as otherwise desired.

The controller 114 may be communicatively coupled to the visual indication means 110 for controlling the visual information provided by the visual indication means 110. In some embodiments, the controller 114 may control the visual indication means 110 based on information received from a user (e.g., via an application on a user device, via a user interface of the pool cover system 104, etc.) and/or based on pre-set information (e.g., default settings). In such embodiments, the controller 114 may control the visual indication means 110 to provide entertainment (e.g., light patterns, digital images, videos, etc.), information (e.g., weather forecast, operational status of the pool, etc.) and/or other visual information as desired. As a non-limiting example, the visual indication means 110 may be controlled to provide simple indications and/or complex light shows. In some embodiments, the controller may control the visual information by controlling one or more characteristics of the visual indication means 110, such as but not limited to a color, brightness, pattern, frequency, activation status, combinations thereof, and/or other characteristics as desired.

Additionally, or alternatively, the controller 114 may control the visual indication means 110 to provide system status information. In such embodiments, the controller 114 may be communicatively connected to various equipment 116 and/or sensors 118 associated with the swimming pool 102, and the visual indication means 110 may be controlled based on information from the equipment 116 and/or sensors 118. As a non-limiting example, the controller 114 may be communicatively connected to a water temperature sensor 118 and/or equipment 116 such as a chemical feeder. In certain embodiments, based on sensed information from the sensor 118 and/or operational status information from the equipment 116, the controller 114 may control the visual indication means 110 to display a certain image, provide light in a particular pattern or color, etc. As an example, the controller 114 may cause the visual indication means 110 to provide red light in a blinking pattern based on the sensed water temperature being below a desired temperature and to provide green light in a solid pattern based on the sensed water temperature being at the desired temperature. Various other controls of the visual indication means 110 may be implemented as desired, and the aforementioned examples should not be considered limiting.

FIG. 2 illustrates another example of a pool cover system 204 according to embodiments. The pool cover system 204 is substantially similar to the pool cover system 104 except that the visual indication means 110 include LEDs 220 provided on the pool cover 106 as the visual indication devices 112. In this embodiment, the pool cover 106 may or may not be constructed from the same material as the pool cover 106 of the pool cover system 204. In other embodiments, other types of light sources and/or visual indication devices may be used in place of or in addition to the LEDs 220. Moreover, the location and number of the LEDs 220 on the pool cover 106 of the pool cover system 204 should not be considered limiting.

Compared to the pool cover system 104, the pool cover system 204 optionally includes one or more on-board power sources, such as but not limited to one or more solar power panels 221 that convert sunlight into electrical energy. The number, location, and arrangement of the solar panels 221 should not be considered limiting, and in other embodiments the solar panels 221 may be omitted. When the solar panels 221 are included, they may store and/or generate electrical energy that may be utilized for other components of the pool cover 106 such as but not limiting to the visual indication means 110. In various embodiments, the one or more solar panels 221 may be flexible, and in some embodiments, the solar panels 221 may be integrated with the pool cover 106. In certain embodiments, the integrated solar panels 221 may be integrated into a plane of the fabric or material forming the pool cover 106. In such embodiments, the solar panels 221 may be rolled up and/or otherwise stowed with the pool cover 106, and when the pool cover 106 is deployed, the solar panels 221 may be at a location within a perimeter of the pool 102. Optionally, the solar panels 221 may be integrated with the pool cover 106 at a location within a perimeter of the pool cover 106.

FIG. 3 illustrates another example of a pool cover system 304 according to embodiments. The pool cover system 304 is substantially similar to the pool cover system 104 except that the visual indication means 110 include LEDs 220 provided along at least a portion of the edge 326 of the pool cover 106, and the pool cover 106 includes a photo-sensitive or other material suitable for receiving light from the LEDs 220 to provide visual information 324 on the pool cover 106. In this embodiment, the LEDs 220 (or other light sources or visual indication sources) may be supported on components of the pool cover system 304 (e.g., a track or support for the pool cover 106), on portions of the pool or pool deck, and/or as otherwise desired.

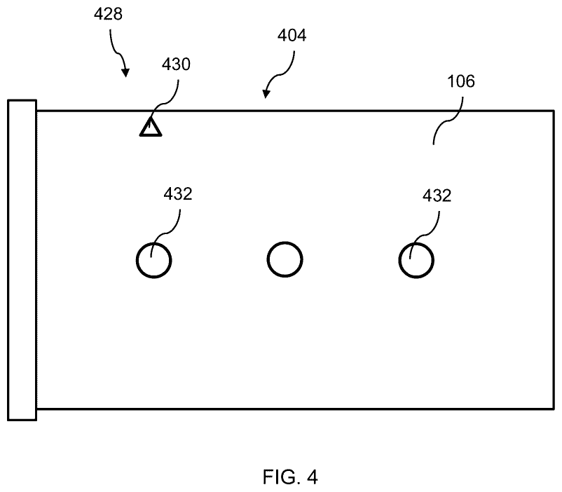

In addition to or alternatively to providing visual information, pool cover systems described herein may have improved drainage control. FIG. 4 illustrates an example of a pool cover system 404 with the pool cover 106 and a drainage system 428 according to embodiments. The drainage system 428 includes sensing means such as one or more sensors 430 or other sensing means for detecting one or more characteristics of water accumulated on the pool cover 106. The one or more characteristics of water on the pool cover 106 may include, but are not limited to, a water depth, a water distribution over the pool cover 106, a duration of water accumulation, a weight of water on the pool cover 106, combinations thereof, and/or other characteristics as desired.

In certain embodiments, the information gathered by the sensors 430 may be used to control drainage means for the pool cover 106 (e.g., using a controller, via direct coupling, etc.). As non-limiting examples, information from the sensors 430 may be used to selectively control one or more cover drains 432 and/or selectively retract the pool cover 106. As an example, the information from the sensor 430 may indicate that water has accumulated towards one end of the pool cover 106 (e.g., the right side in FIG. 4), and the most proximate cover drain 432 may be controlled to allow drainage of the water. As another example, the cover drains 432 may be controlled to discharge accumulated water based on the sensed duration of water accumulation meeting a threshold duration for discharging water. Various other controls may be implemented using the drainage systems described herein.

The aforementioned examples of features provided within the pool covers are for illustrative purposes only and should not be considered limiting, and in other embodiments, other types of features may be provided with pool covers as desired.

Exemplary concepts or combinations of features of the invention may include:
A. A pool cover for a swimming pool or spa, the pool cover configured to provide a changeable or adjustable visual indication.
B. A pool cover for a swimming pool or spa, the pool cover comprising integrated lighting.
C. The pool cover of any preceding or subsequent statement or combination of statements, wherein the integrated lighting comprises LEDs.
D. A pool cover for a swimming pool or spa the pool cover comprising a photosensitive material.
E. The pool cover of any preceding or subsequent statement or combination of statements, further comprising a light source along at least a portion of a perimeter of the pool cover.
F. A pool cover for a swimming pool or spa, the pool cover comprising a media reflective surface.
G. A pool cover for a swimming pool or spa, the pool cover comprising a controllable visual indicator.
H. A pool cover for a swimming pool or spa, the pool cover configured to provide a pool system status.
I. A pool cover for a swimming pool or spa, the pool cover comprising a solar panel configured to convert sunlight into electrical energy.
J. A method of providing a pool system status comprising controlling a visual indicator on a pool cover based on the pool system status. K. A pool cover comprising a surface water sensor for detecting at least one characteristic of water accumulated on the pool cover.
L. The pool cover of any preceding or subsequent statement or combination of statements, wherein the at least one characteristic comprises a depth of water on the pool cover or a weight of water on the pool cover.
M. A drainage system for a pool cover, the drainage system comprising a surface water sensor for detecting at least one characteristic of water accumulated on the pool cover and drainage means controllable based on information from the surface water sensor.
N. The drainage system of any preceding or subsequent statement or combination of statements, wherein the at least one characteristic comprises a depth of water on the pool cover or a weight of water on the pool cover.
O. The pool cover of any preceding or subsequent statement or combination of statements, further comprising a drainage system controllable based on information from the surface water sensor.
P. The pool cover of any preceding or subsequent statement or combination of statements, wherein the drainage system comprises a plurality of drains on the pool cover, and wherein each drain is independently controlled.
Q. A method of controlling a pool cover comprises controlling a visual indicator on a pool cover.
R. The method of any preceding or subsequent statement or combination of statements, further comprising providing a pool system status by controlling the visual indicator based on the pool system status.
S. The method of any preceding or subsequent statement or combination of statements, wherein controlling the visual indicator comprises controlling the visual indicator based on information received from a user.
T. The method of any preceding or subsequent statement or combination of statements, wherein controlling the visual indicator comprises controlling the visual indicator based on pre-set information.

U. The method of any preceding or subsequent statement or combination of statements, wherein controlling the visual indicator comprises providing an entertainment display on the pool cover, wherein the entertainment display comprises at least one of a light pattern, an image, or a video on the pool cover.
V. The method of any preceding or subsequent statement or combination of statements, wherein controlling the visual indicator comprises providing a weather forecast on the pool cover.
W. A pool cover for a swimming pool or spa, the pool cover comprising an integrated solar panel, the integrated solar panel configured to convert sunlight into electrical energy.
X. The pool cover of any preceding or subsequent statement or combination of statements, wherein the integrated solar panel is configured to power a light source on the pool cover or remote from the pool cover.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy and for which selective covering or uncovering is needed or desired.

That which is claimed:

1. A pool cover for a swimming pool or spa, the pool cover configured to provide a changeable or adjustable visual indication.

2. The pool cover of claim 1, wherein the pool cover is configured to provide a pool system status using the changeable or adjustable visual indication.

3. The pool cover of claim 1, wherein the pool cover comprises integrated lighting.

4. The pool cover of claim 1, wherein the pool cover comprises a photosensitive material.

5. The pool cover of claim 1, wherein the pool cover comprises a light source along at least a portion of a perimeter of the pool cover.

6. The pool cover of claim 1, wherein the pool cover comprises a media reflective surface.

7. The pool cover of claim 1, wherein the pool cover comprises a controllable visual indicator.

8. A pool cover for a swimming pool or spa, the pool cover comprising an integrated solar panel configured to convert sunlight into electrical energy.

9. The pool cover of claim 8, wherein the integrated solar panel is configured to power a light source on the pool cover or remote from the pool cover.

10. A method of controlling a pool cover comprises controlling a visual indicator on a pool cover.

11. The method of claim 10, further comprising providing a pool system status by controlling the visual indicator based on the pool system status.

12. The method of claim 10, wherein controlling the visual indicator comprises controlling the visual indicator based on information received from a user.

13. The method of claim 10, wherein controlling the visual indicator comprises controlling the visual indicator based on pre-set information.

14. The method of claim 10, wherein controlling the visual indicator comprises providing an entertainment display on the pool cover, wherein the entertainment display comprises at least one of a light pattern, an image, or a video on the pool cover.

15. The method of claim 10, wherein controlling the visual indicator comprises providing a weather forecast on the pool cover.

16. A pool cover for a swimming pool or spa, the pool cover comprising a surface water sensor for detecting at least one characteristic of water accumulated on the pool cover.

17. The pool cover of claim 16, wherein the at least one characteristic comprises a depth of water on the pool cover.

18. The pool cover of claim 16, wherein the at least one characteristic comprises a weight of water on the pool cover.

19. The pool cover of claim 16, further comprising a drainage system controllable based on information from the surface water sensor.

20. The pool cover of claim 19, wherein the drainage system comprises a plurality of drains on the pool cover, and wherein each drain is independently controlled.
